(19) United States
(12) Patent Application Publication
(10) Pub. No.: US 2021/0188436 A1
(43) Pub. Date: Jun. 24, 2021

(54) PHOTOGRAPHING DEVICE, GIMBLE CAMERA, AND UNMANNED AERIAL VEHICLE

(71) Applicant: SZ DJI TECHNOLOGY CO., LTD., Shenzhen (CN)

(72) Inventors: Yong LIU, Shenzhen (CN); Tianhang MA, Shenzhen (CN)

(21) Appl. No.: 17/192,881

(22) Filed: Mar. 4, 2021

Related U.S. Application Data
(63) Continuation of application No. PCT/CN2018/107731, filed on Sep. 26, 2018.

(51) Int. Cl. B64C 39/02; G03B 17/56; H04N 5/225; F16M 11/12

(52) U.S. Cl. CPC B64C 39/024; G03B 17/561; B64C 2201/127; F16M 11/12; H04N 5/2254

(57) ABSTRACT

A photographing device includes a housing, a fill light mounted at the housing, and a lens module mounted in the housing. Relative position and attitude of the fill light relative to the lens module are fixed. An optical axis of the fill light is approximately parallel to an optical axis of the lens module. The lens module and the fill light rotate together with the housing.

### CROSS-REFERENCE TO RELATED APPLICATION

This application is a continuation of International Application No. PCT/CN2018/107731, filed Sep. 26, 2018, the entire content of which is incorporated herein by reference.

### TECHNICAL FIELD

The present disclosure relates to the field of photographing technology and, in particularly, to a photographing device, a gimble camera, and an unmanned aerial vehicle.

### BACKGROUND

A camera is a device using the principle of optical imaging to form and record images, which is a product integrating optics, machinery, and electronics. The camera integrates members such as an image information conversion member, an image storage member, and an image transmission member. The camera has characteristics such as digital access mode, interactive processing with a computer, real-time shooting, and etc.

The imaging process of the camera includes light entering the camera through a lens or a lens group, converting the light into a digital signal by an imaging element, and storing the digital signal in a storage device via an image processing chip. In the related art, the imaging element of the camera is Charge Coupled Device (CCD), or Complementary Metal-Oxide-Semiconductor (CMOS). When the light passes through the imaging element, the imaging element converts different light into corresponding electronic signals, and then the corresponding electronic signals are recorded and read. However, when the camera is in a low light condition or an insufficient light condition, the image quality of the photo taken by the camera is poor, thereby seriously affecting the using experience of the user.

In the related art, an active stabilization gimbal camera does not have a fill light, or a fill light is provided at the base or another part. Because the fill light is provided at a part such as the base, when the gimble camera rotates, the fill light cannot rotate and follow the object in real time according to the rotation of the gimble camera, thereby causing a poor fill light effect.

### SUMMARY

In accordance with the disclosure, there is provided a photographing device including a housing, a fill light mounted at the housing, and a lens module mounted in the housing. Relative position and attitude of the fill light relative to the lens module are fixed. An optical axis of the fill light is approximately parallel to an optical axis of the lens module. The lens module and the fill light rotate together with the housing.

Also in accordance with the disclosure, there is provided a gimbal camera including a photographing device and a gimbal coupled to the photographing device and configured to drive the photographing device to rotate and to adjust a shooting direction of the photographing device. The photographing device includes a housing, a fill light mounted at the housing, and a lens module mounted in the housing. Relative position and attitude of the fill light relative to the lens module are fixed. An optical axis of the fill light is approximately parallel to an optical axis of the lens module. The lens module and the fill light rotate together with the housing.

Also in accordance with the disclosure, there is provided an unmanned aerial vehicle including an aerial vehicle body and a gimbal camera carried by the aerial vehicle body and communicatively coupled to the aerial vehicle body. The gimbal camera includes a photographing device and a gimbal coupled to the photographing device and configured to drive the photographing device to rotate and to adjust a shooting direction of the photographing device. The photographing device includes a housing, a fill light mounted at the housing, and a lens module mounted in the housing. Relative position and attitude of the fill light relative to the lens module are fixed. An optical axis of the fill light is approximately parallel to an optical axis of the lens module. The lens module and the fill light rotate together with the housing.

### BRIEF DESCRIPTION OF THE DRAWINGS

FIG. 1 is a schematic structural diagram of an example photographing device consistent with the disclosure.

FIG. 2 is a schematic exploded structural diagram of an example photographing device consistent with the disclosure.

FIG. 3 is a schematic structural diagram of an example light guide lens consistent with the disclosure.

FIG. 4 is a schematic structural diagram of an example fill light consistent with the disclosure.

FIG. 5 is a schematic exploded structural diagram of an example gimbal camera consistent with the disclosure.

FIG. 6 is a schematic structural diagram showing a front view of an example handheld gimbal camera consistent with the disclosure.

FIG. 7 is a schematic structural diagram showing a perspective view of the example handheld gimbal camera from a first angle.

FIG. 8 is a schematic structural diagram showing a perspective view of the example handheld gimbal camera from a second angle.

FIG. 9 is a schematic structural diagram of an example unmanned aerial vehicle with an example gimbal camera consistent with the disclosure.

Reference numerals: Housing 10; Lens hole 11; Light hole 12; Hood 13; Lens cover member 131; Connector 132; Casing 14; Front Casing 141; Rear Casing 142; Mounting hole 143; Mounting member 144; Lens module 20; Lens assembly 21; Lens board 22; Contact 221; Heat dissipation assembly 23; Fill light 30; Elevated base 31; Base body 311; Conductive interface 312; Luminous body 32; Lens group 40; Light guide lens 41; Flange member 411; Light guide member 412; Protection lens 42; Photographing device 100; Gimbal 200; Pitch axis member 201; Yaw axis member 202; Roll axis member 203; Aerial vehicle body 300; Handheld member 400; Operation member 401.

### DETAILED DESCRIPTION OF THE EMBODIMENTS

Technical solutions in the embodiments of the present disclosure will be described below with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The photographing device, gimbal camera and unmanned aerial vehicle of the present disclosure will be described in detail below with reference to the drawings. As long as there is no conflict, the following embodiments and features of the embodiments may be combined with each other.

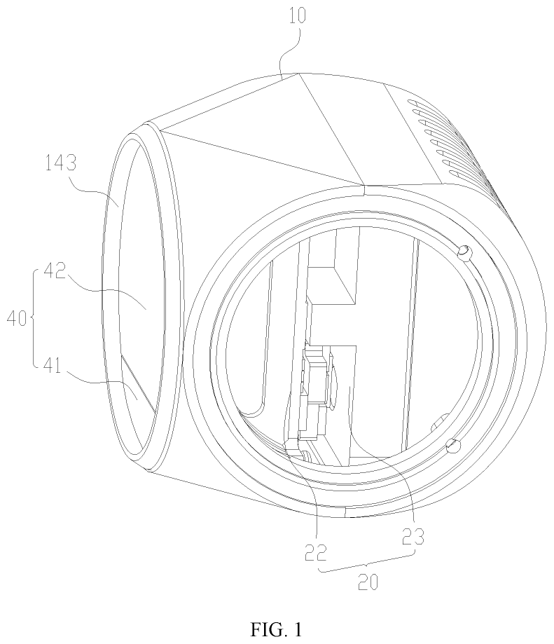

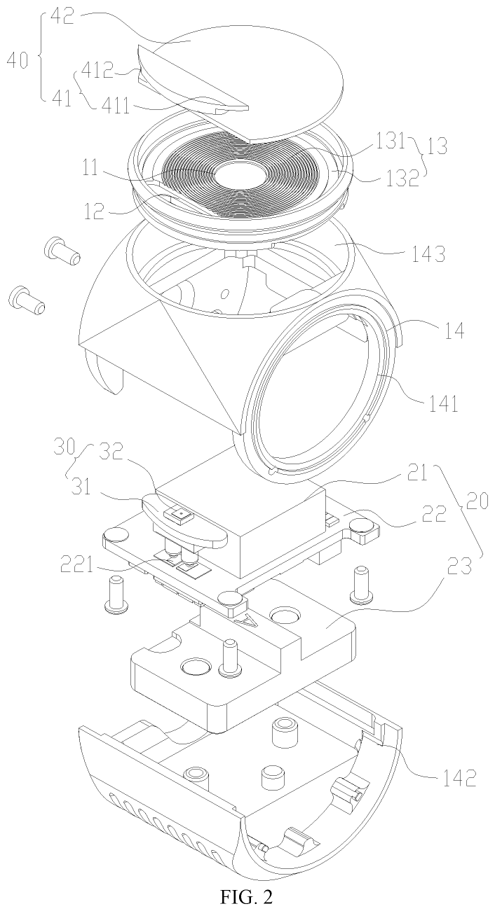

FIG. 1 is a schematic structural diagram of an example photographing device 100 consistent with the disclosure. FIG. 2 is a schematic exploded structural diagram of the example photographing device 100. As shown in FIG. 1 and FIG. 2, the photographing device 100 includes a housing 10, a fill light 30 mounted at the housing 10, and a lens module 20 mounted in the housing 10. The relative position and attitude of the fill light 30 relative to the lens module 20 are fixed, and the optical axis of the fill light 30 is approximately parallel to the optical axis of the lens module 20. The housing 10 isolates the luminous part of the fill light 30 from the lens module 20, and the lens module 20 and the fill light 30 rotate together with the housing 10.

The housing 10 is a hollow structure. The lens module 20 and the fill light 30 are mounted at the housing 10, where the lens module 20 is mounted in the housing 10. The fill light 30 may be mounted in the housing 10 and emit light out of the housing 10 along the shooting direction parallel to the lens module 20, or the fill light 30 may be mounted on the surface of the housing 10 and emit light in a direction parallel to a shooting direction of the lens module 20. The lens module 20 is configured to receive light entering into the housing 10, including light emitted by the fill light 30 and reflected by a shooting object, to convert the light into corresponding image information, and to output the corresponding image information. The housing 10 isolates the luminous part of the fill light 30 from the lens module 20 to prevent the light emitted by the fill light 30 from passing through the housing 10 and affecting the photosensitive performance of the lens module 20, thereby reducing interference.

Both the lens module 20 and the fill light 30 are fixed at the housing 10. When the photographing device 100 rotates around one of the axes, both the lens module 20 and the fill light 30 may rotate with the housing 10 to achieve good synchronization of rotation. The optical axis of the lens module 20 and the optical axis of the fill light 30 are arranged approximately in parallel, and the light emitted by the fill light 30 may be in the same direction as the shooting object of the lens module 20 to achieve a good fill light effect and high shooting quality.

In an embodiment, the housing 10 includes a lens hole 11 and a light hole 12 arranged side by side. The lens module 20 is arranged corresponding to the lens hole 11, and the fill light 30 is located in the light hole 12. The photographing device 100 further includes a lens group 40 configured to cover the lens hole 11 and the light hole 12.

The lens hole 11 and the light hole 12 are arranged at the housing 10 and spaced apart from each other. The central line of the lens hole 11 and the central line of the light hole 12 are approximately parallel to each other. The central axis of the lens module 20 coincides with or parallel to the central line of the lens hole 11, the lens module 20 may shoot the object via the lens hole 11, and the light may be sensed by the lens module 20 via the lens hole 11. The central axis of the light from the fill light 30 may be coincide with or parallel to the central line of the light hole 12, and the fill light 30 may emit light towards the object via the light hole 12 to achieve a stable light emission direction of the fill light 30 and a high concentration of the light.

In some embodiments, the light hole 12 penetrates the housing 10, and the fill light 30 is mounted in the housing 10 and spaced apart from the lens module 20. In some embodiments, the housing 10 is provided with a tubular protrusion, the light hole 12 is formed at the enclosed space of the tubular protrusion, and the fill light 30 is mounted in the tubular protrusion and separated from the lens module 20 by the wall of the housing 10.

The lens group 40 is mounted at the housing 10 and correspondingly covers both the lens hole 11 and the light hole 12 to prevent foreign matter from entering the housing 10 via the lens hole 11 or the light hole 12. The lens group 40 may be made of light transmission material, such as glass, synthetic resin. In some embodiments, patterns and shapes of the lens group 40 can be correspondingly configured such that the light path for receiving or emitting light by the lens group 40 can be adaptively changed to achieve better imaging quality of the lens module 20.

In an example embodiment, the lens group 40 includes a monolithic lens, which is fixed to the housing 10 and covers both the lens hole 11 and the light hole 12.

In an example embodiment, the lens group 40 includes a protection lens 42 and a light guide lens 41. The protection lens 42 is configured to cover the lens hole 11, and the light guide lens 41 is configured to cover the light hole 12. The protection lens 42 and the light guide lens 41 are separately arranged and mounted at the housing 10 to enable the lens module 20 to receive the light passing through the protection lens 42 and to generate corresponding image information. The fill light 30 may emit light outwards via the light guide lens 41 to enable the lens module 20 to obtain better imaging quality. The protection lens 42 and the light guide lens 41 are arranged separately to enable both the protection lens 42 and the light guide lens 41 to be processed easily. The protection lens 42 and the light guide lens 41 are configured to adjust the guiding direction and the refraction direction of the light, respectively, to achieve good flexibility of use.

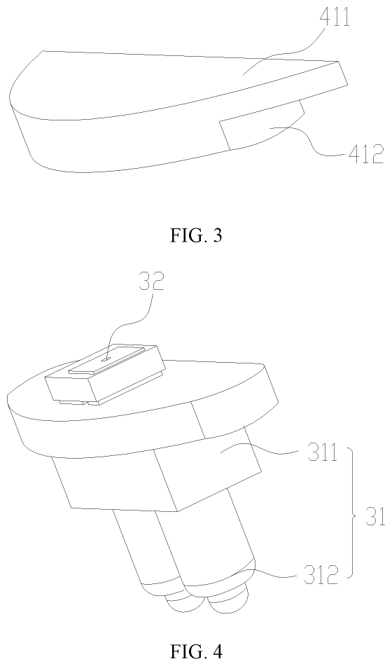

As shown in FIG. 2 and FIG. 3, in an example embodiment, the light guide lens 41 is plug-connected to the light hole 12. The fill light 30 is arranged corresponding to the light hole 12, and the light guide lens 41 is plug-connected to the light hole 12 to enable the light guide lens 41 to be closely matched with the light hole 12. In some embodiments, the light hole 12 has a hole-shaped structure. For example, the light hole 12 is configured as, e.g., a round hole, an elliptical hole, a hole-shaped structure provided with a positioning plane, or a hole-shaped structure with an arc-shaped cross section. In some embodiments, the shape of the cross section of the light guide lens 41 matches the light hole 12, that is, the cross section of the light guide lens 41 is approximately the same as the cross section of the light hole 12. In some embodiments, the light guide lens 41 is plug-connected to the light hole 12 and there is a gap between part of the light guide lens 41 and the inner wall of the light hole 12. The light guide lens 41 is plug-connected to the light hole 12 and hence an accuracy of positioning is high.

The light guide lens 41 is fixed to the assembly position of the housing 10. The position of the fill light 30 relative to the light guide lens 41 is adjusted to achieve a high concentration of the light transmitted by the fill light 30 via the light guide lens 41, and to cause the position of the fill light 30 to be easily adjusted.

In an example embodiment, the light guide lens 41 includes a light guide member 412 and a flange member 411 protruding from the light guide member 412. The light guide member 412 is inserted to the light hole 12, and the flange member 411 matches the protection lens 42 and is mounted at the housing 10.

The light guide member 412 and the flange member 411 are integrally formed. When the light guide lens 41 is mounted at the housing 10, the flange member 411 abuts against the housing 10 and matches the protection lens 42, and the light guide member 412 extends into the housing 10 through the light hole 12. The fill light 30 is located in the moving direction of one end of the light guide member 412, and the light guide member 412 is configured to guide the light emitted by the fill light 30 to pass through the light guide lens 41 and to be emitted outwards through the flange member 411 of the light guide lens 41. The flange member 411 limits the insertion depth and the insertion position of the light guide member 412 to enable the end surface of the light guide member 412 to be separated from the fill light 30 by a preset distance, thereby maintaining a concentration of light projection.

In an example embodiment, the side wall of the light guide lens 41 abuts against the side wall of the protection lens 42 and is smoothly connected at the edge where the two intersect. A part of the edge of the flange member 411 is attached to the protection lens 42 to cause another part of the edge of the protection lens 42 and another part of edge of the flange member 411 to form a smoothly transitioned curved surface or a preset shape. For example, the edges of the protection lens 42 and the light guide lens 41 abut against each other, and the outer edges of the protection lens 42 and the light guide lens 41 form a circular structure. As another example, the edges of the protection lens 42 and the light guide lens 41 abut against each other, and the light guide lens 41 partially protrudes from the edge of the protective lens 42. The protection lens 42 and the flange member 411 are attached to each other for a good overall appearance.

In an example embodiment, the light guide lens 41 and the protection lens 42 are combined to form a circular lens group 40, the light guide lens 41 includes a curved mirror surface, and the remaining part of the lens group 40 is the protection lens 42. In some embodiments, the central line of the lens hole 11 coincides with the axis of the lens group 40. The light hole 12 is deviated from the lens hole 11 by a preset distance, and the light guide lens 41 is arranged corresponding to the light hole 12.

In an embodiment, the light guide lens 41 is separated from the fill light 30 by a preset distance, and the light guide lens 41 is configured to adjust the outward emission direction of the light emitted from the fill light 30 and transmitted through the light guide lens 41. The light guide lens 41 is mounted at the housing 10, and the light emitted by the fill light 30 may pass through the light guide lens 41 and be emitted outwards. The shape of the light guide lens 41 is configured to change and adjust the light emission direction. For example, one surface of the light guide lens 41 includes a curved surface or a concave-convex structure to change the light path. Correspondingly, the position of the fill light 30 relative to the light guide lens 41 is adjusted to enable the light emitted by the fill light 30 to pass through the light guide lens 41 and to be output according to a preset trajectory. For example, the light is converged to a focal position, is emitted as parallel light, etc.

In an example embodiment, the light guide lens 41 includes a Fresnel lens, and the fill light 30 is located at the focal point of the light guide lens 41. In some embodiments, the fill light 30 is located at the focal point on the light-converging side of the light guide lens 41. Correspondingly, the light emitted from the fill light 30 to the surroundings is refracted by the light guide lens 41 to form a parallel beam, which is emitted towards the shooting object to achieve a high light concentration and a good fill light effect.

The housing 10 is used to mount the lens module 20 and other accessory, and includes a plurality of components. In an embodiment, as shown in FIG. 2, the housing 10 includes a casing 14 and a hood 13 mounted at the casing 14. The lens hole 11 and the light hole 12 are arranged side by side at the hood 13, and the lens module 20 is mounted in the casing 14 and extends towards the lens hole 11.

The casing 14 has a hollow structure. An opening is provided at the casing 14 and a mounting space is provided in the casing 14. The lens module 20 is located in the mounting space and is fixed to the casing 14. The hood 13 is a part of the housing 10, and the hood 13 is mounted at the opening of the casing 14 to enable the lens module 20 to be enclosed in the housing 10. Both the lens hole 11 and the light hole 12 are opened at the hood 13.

The lens module 20 is mounted at the casing 14, which is convenient for mounting and has a large operation space. The hood 13 is mounted at the housing 10 and approaches the lens module 20. The lens module 20 and the hood 13 are close to each other to enable the lens module 20 to be close to the lens hole 11, thereby achieving a good shooting effect and a large shooting range of the lens module 20.

In an example embodiment, the casing 14 is provided with a mounting hole 143, and the hood 13 is mounted at the mounting hole 143. The lens group 40 is mounted at the hood 13 and covers both the lens hole 11 and the light hole 12. This enables the mounting space to transmit light via the lens hole 11 and the light hole 12 at the hood 13. In some embodiments, the hood 13 and the mounting hole 143 may use one of a screw-connection, an interference-fit, a snap-connection, a fastener-connection, a glue-connection, or another connection method to enable the hood 13 to be tightly connected to the casing 14. In an example embodiment, the hood 13 and the casing 14 are snap-connected to each other.

The lens group 40 is mounted at the hood 13 and covers both the lens hole 11 and the light hole 12 opened at the hood 13, and the casing 14 covers the openings via the hood 13 and the lens group 40, which is convenient for assembly. The light may be refracted by the lens group 40 and enter the housing 10 through the lens hole 11, or the light emitted by the fill light 30 may transmit outwards to the lens group 40 through the light hole 12 and be emitted outwards after being refracted by the lens group 40, to achieve smooth light transmission.

In an example embodiment, the mounting hole 143 has a circular hole structure, the hood 13 has an annular structure, and the hood 13 is inserted into the mounting hole 143 and locked to the casing 14. In some embodiments, the outer side wall of the hood 13 is provided with flange-shaped protrusions protruding from the surface, the hood 13 is inserted and connected to the mounting hole 143, and the flange-shaped protrusion abuts against the end wall surface of the mounting hole 143 to achieve a high accuracy of positioning.

Both the lens hole 11 and the light hole 12 penetrate the hood 13, and the lens group 40 is attached to the surface of the hood 13 to cover the lens hole 11 and the light hole 12. In some embodiments, a groove is provided at the hood 13, and both the lens hole 11 and the light hole 12 are located at the bottom of the groove. The lens group 40 is mounted at the groove and covers the lens hole 11 and the light hole 12, which is convenient to assemble. When the lens group 40 includes multiple lenses, the edge contour of the lens group 40 matches the shape of the side wall of the groove. For example, when the groove is a circular or a tapered counterbore, the edge contour of the lens group 40 is a circular.

In an example embodiment, the hood 13 includes a lens cover member 131 and a connector 132 surrounding the lens cover member 131 and detachably connected to the casing 14. Both the lens hole 11 and the light hole 12 are provided at the lens cover member 131, and the lens hole 11 and the light hole 12 are separated from each other by a preset distance. The connector 132 has an annular structure, and the connector 132 and the lens cover member 131 constitute a groove structure. The lens cover member 131 is located in the connector 132 and at a preset depth from the end of the connector 132. For example, the depth of the concave region of both the lens cover member 131 and the connector 132 is 2 mm to 8 mm. The connector 132 may be connected to the mounting hole 143 of the casing 14 via a snap-connection or an interference fit. In some embodiments, the surface of the connector 132 partially protrudes to form a flange member 411, which is used to limit the assembly position of the connector 132 and the casing 14 to achieve a high accuracy of positioning. Both the lens hole 11 and the light hole 12 are opened at the lens cover member 131. In some embodiments, the lens hole 11 is located at the center of the lens cover member 131, and the center of the light hole 12 is separated from the center of the lens hole 11 by a preset distance. For example, the light hole 12 is at the edge of the lens cover member 131 and extends to the connector 132.

In an example embodiment, the casing 14 includes a front casing 141 and a rear casing 142 detachably mounted at the front casing 141, a mounting space is formed between the front casing 141 and the rear casing 142, and both the hood 13 and the lens module 20 are mounted at the front casing 141 and located in the mounting space.

The hood 13, the fill light 30, and the lens module 20 are mounted at the front casing 141. The relative position adjustments between the hood 13, the fill light 30, and the lens module 20 all can be performed at the front casing 141. As such, large operation space and convenient assembly can be achieved. The front casing 141 is mounted at the rear casing 142 to enable both the front casing 141 and the rear casing 142 to be detachably connected, thereby achieving a high efficiency of assembling.

As shown in FIG. 2 and FIG. 4, in an embodiment, the fill light 30 is mounted at the lens module 20 or the housing 10, and is electrically connected to the lens module 20. The fill light 30 is driven by electrical energy to emit light. The fill light 30 and the lens module 20 share a power supply circuit to reduce the complexity of the connection circuit of the fill light 30 and the lens module 20, and to reduce the required mounting space.

In an example embodiment, the lens module 20 includes a lens board 22 and a lens assembly 21 mounted at the lens board 22. The lens board 22 is detachably mounted at the housing 10 and used to adjust the shooting direction of the lens assembly 21 relative to the housing 10. The fill light 30 is mounted at the lens board 22 and electrically connected to the lens board 22.

The fill light 30 is directly mounted at the lens module 20, where both the fill light 30 and the lens assembly 21 are mounted at the lens board 22. The position of the fill light 30 relative to the lens assembly 21 at the lens board 22 is adjusted to cause the optical axis of the fill light 30 and the optical axis of the lens assembly 21 to be approximately parallel to each other. When the shooting direction or angle of the lens assembly 21 is adjusted via the lens board 22, the emission angle and direction of the fill light 30 are adjusted with the lens board 22, thereby achieving a high efficiency of adjustment and good consistency of the fill light 30 and the lens assembly 21.

The fill light 30 is mounted at the housing 10 and electrically connected to the lens assembly 21 via a wire, to enable the fill light to share the power supply circuit of the lens assembly 21, or to enable the power supply circuit of the fill light 30 to be provided at the lens board 22, thereby achieving a small overall volume of the fill light 30 and being convenient to adjust the assembly position at the housing 10. The fill light 30 may separately adjust the corresponding light emission direction, and the lens assembly 21 may separately adjust the corresponding shooting direction to prevent the fill light 30 and the lens assembly 21 from interfering with each other and to achieve a good adjustment effect.

In an example embodiment, the fill light 30 includes an elevated base 31 mounted at the lens module 20 or the housing 10, and a luminous body 32 mounted at the elevated base 31 and electrically connected to the lens module 20.

The luminous body 32 is mounted at the elevated base 31 and connected with the conductive circuit provided at the elevated base 31. The elevated base 31 is mounted at the lens module 20 or the housing 10 to adjust the position of the luminous body 32 relative to the light hole 12 and the position and angle of the optical center of the luminous body 32, thereby causing the position of the luminous body 32 to be easily adjusted. In some embodiments, at least a part of the luminous body 32 extends into the light hole 12 and is close to the lens group 40. In an embodiment, the optical center of the luminous body 32 is located at the focal point of the light guide lens 41 of the Fresnel lens type. In some embodiments, the luminous body 32 is an LED lamp.

The elevated base 31 includes a base body 311 and two conductive interfaces 312 fixed at the base body 311 and electrically connected to the luminous body 32. In some embodiments, the two conductive interfaces 312 may be connected to the lens module 20 via wires to enable the luminous body 32 to be electrically connected to the lens module 20. In some other embodiments, the two conductive interfaces 312 may protrude from the base body 311 and be connected to the lens module 20 via, e.g., soldering, plug-in conductive connections, contact crimp connections, etc., to enable the conductive interfaces 312 to be conductively connected to the lens module 20 and to achieve a good contact effect. In some embodiments, the two conductive interfaces 312 are arranged in parallel.

In some embodiments, the base body 311 of the elevated base 31 is provided with an edge contour that matches the light hole 12, and a part of the base body 311 is inserted in the light hole 12 to enable the luminous body 32 to be located at a preset position of the light hole 12 and to achieve a high accuracy of positioning.

In an example embodiment, the luminous body 32 is inserted in the housing 10, and the elevated base 31 is attached to the housing 10 and encloses the luminous body 32 in the housing 10. The luminous body 32 is inserted into the light hole 12 of the housing 10 to cause the light emitted by the luminous body 32 to be concentrated in the light hole 12. The elevated base 31 is mounted at one end, which is attached to the housing 10 and covers the light hole 12, to cause the light emitted by the luminous body 32 to only pass through another end of the light hole 12 and to transmit outwards via the lens group 40, thereby reducing loss of light and achieving a high light concentration.

In an example embodiment, the lens board 22 is provided with a contact 221 electrically connected to the fill light 30. The contact 221 is provided at the lens board 22 and connected with the power supply circuit or the control circuit in the lens board 22, and the fill light 30 is conductively connected to the contact 221, which is convenient for the electrical connection. In some embodiments, the conductive interface 312 of the fill light 30 may be connected to the contact 221 via a wire to enable the luminous body 32 to be electrically connected. In some other embodiments, the contact 221 may be a metal conductive contact provided at the surface of the lens board 22, and the conductive interface 312 of the fill light 30 may abut against the contact 221 to enable the luminous body 32 to be electrically connected.

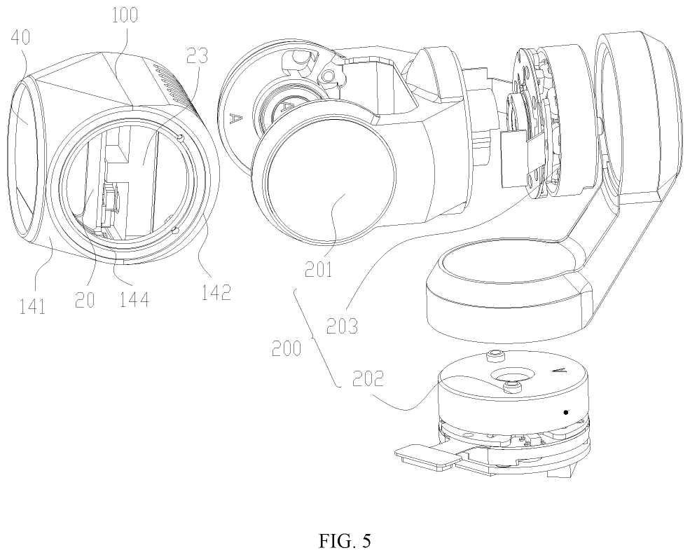

As shown in FIGS. 2 and 5, in an example embodiment, the lens module 20 also includes a heat dissipation assembly 23 attached to the heat generating part of the lens board 22. The lens assembly 21 is mounted at the lens board 22. When the lens assembly 21 receives light and converts to image information, a sensor at the lens board 22 may generate a lot of heat, and other elements, such as a processor, mounted at the lens board 22 may also generate a lot of heat. The heat dissipation assembly 23 is mounted at the housing 10 and attached to a heat generation part of the lens board 22 to cause the heat generated at the heat generation part of the lens board 22 to be dissipated via the heat dissipation assembly 23, and to enable the lens module 20 to be kept at a suitable working temperature, thereby achieving a high efficiency of image processing.

In an example embodiment, both the lens module 20 and the luminous body 32 are mounted at the front casing 141, and the heat dissipation assembly 23 is mounted at the rear casing 142. The rear casing 142 is mounted at the front casing 141 by, e.g., a snap-connection, or a fastener-connection, etc. The heat dissipation assembly 23 is close to or attached to the heat generation part of the lens module 20. In some embodiments, a heat-conducting medium made of a heat-conducting material, such as a heat-conducting glue, a heat-conducting pad, etc., is provided between the heat dissipation assembly 23 and the lens module 20. As such, the heat generated by the lens module 20 can be transferred to the heat dissipation assembly 23 via the heat-conducting medium and then be emitted to external atmosphere via the heat dissipation assembly 23 and/or the housing 10, thereby achieving a good heat dissipation effect.

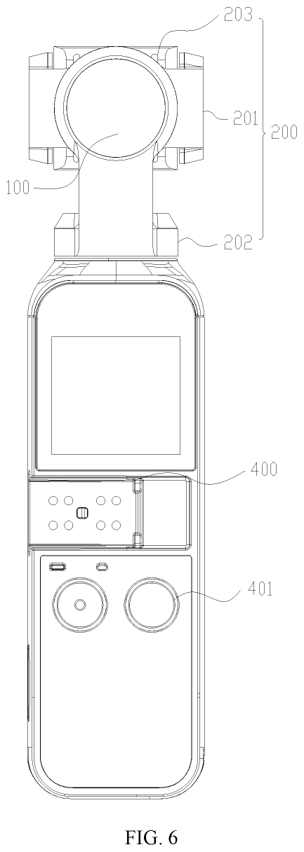

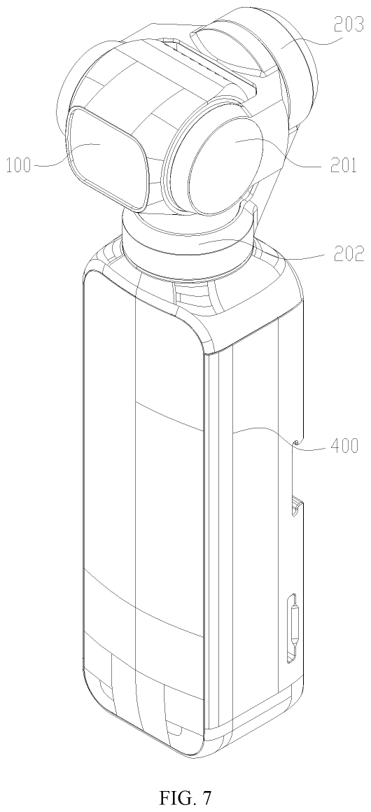

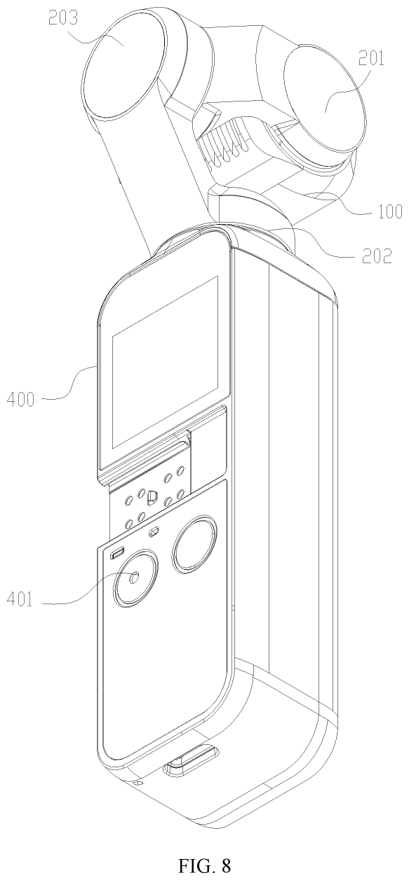

FIG. 5 is a schematic exploded structural diagram of an example gimbal camera consistent with the disclosure. FIG. 6 is a schematic structural diagram showing a front view of an example handheld gimbal camera consistent with the disclosure. FIG. 7 is a schematic structural diagram showing a perspective view of the example handheld gimbal camera from a first angle. FIG. 8 is a schematic structural diagram showing a perspective view of the example handheld gimbal camera from a second angle. As shown in FIG. 5 to FIG. 8, in an embodiment, the gimbal camera includes a gimbal 200 and the example photographing device 100 described above in connection with FIG. 1 to FIG. 4. The gimbal 200 is used to drive the photographing device 100 to rotate and adjust the shooting direction of the photographing device 100. The above-described photographing device 100 is applied to the gimbal camera, such that the fill light 30 can rotate synchronously with the lens module 20 and always follow the shooting object when the gimbal 200 drives the photographing device 100 to rotate, thereby providing a suitable fill light effect for the lens module 20 and improving the imaging quality of the lens module 20.

In an example embodiment, the gimbal 200 includes a pitch axis member 201. The photographing device 100 is mounted at the pitch axis member 201, and the pitch axis member 201 drives the photographing device 100 to rotate around the axis of the pitch axis member 201. The housing 10 is provided with a mounting member 144 fixedly connected with the pitch axis member 201 to enable the pitch axis member 201 to drive the photographing device 100 to rotate during the rotation of the pitch axis member 201. For example, the rotation angle range of the pitch axis member 201 is a rotation range of −90° to 100°, and the rotation angle range of the photographing device 100 is the same as that of the pitch axis member 201, which is the rotation range of −90° to 100°.

In an example embodiment, the mounting member 144 is a shaft hole opened at the housing 10, and the pitch axis member 201 is provided with a high-precision stabilization motor, which is connected to the housing 10 and corresponds to the shaft hole. The rotation axis of the high-precision stabilization motor coincides with the axis of the rotation shaft hole, and the axis of the rotation shaft hole is perpendicular to the shooting direction of the lens module 20.

In an example embodiment, the mounting member 144 is a rotation shaft protruding from the housing 10, and the pitch axis member 201 is provided with a high-precision stabilization motor, which is connected to the rotation shaft. The rotation shaft of the high-precision stabilization motor coincides with the axis of the rotation shaft, and the axis of the rotation shaft is perpendicular to the shooting direction of the lens module 20.

In an embodiment, the gimbal 200 also includes a yaw axis member 202 and a roll axis member 203 rotatably mounted at the yaw axis member 202. The yaw axis member 202 drives the roll axis member 203 to rotate around the axis of the yaw axis member 202. The pitch axis member 201 is mounted at the roll axis member 203, and the roll axis member 203 drives the pitch axis member 201 to rotate around the axis of the roll axis member 203.

The gimbal 200 is a three-axis gimbal 200, which may drive the photographing device 100 to rotate flexibly with a large angle, and the photographing device 100 may shoot corresponding image information, thereby causing the shooting angle to be adjusted easily and achieving a good flexibility. For example, the yaw axis member 202 rotates within a yaw angle of ±160° to cause the yaw shooting angle of the photographing device 100 to reach ±160°. The roll axis member 203 rotates within a roll angle of ±90° to cause the roll shooting angle of the photographing device 100 to reach ±90°.

The gimbal 200 may drive the photographing device 100 to rotate according to a corresponding control instruction, to achieve good controllability of the shooting direction of the photographing device 100. The fill light 30 may move synchronously with the rotation of the photographing device 100, which may provide the lens module 20 with a good fill light effect in time. As such, when the shooting scene of the photographing device 100 changes or the photographing device 100 needs to shoot in a low light condition, the fill light 30 can always follow the object, and the light emission direction can always be consistent with the shooting direction of the lens module 20. Therefore, the fill light 30 can provide fill light to the object in time and the lens module 20 can obtain clear image information of the object, thereby achieving a good shooting effect.

In an embodiment, the gimbal 200 is in communicative connection with the photographing device 100, and the fill light 30 is turned on when the gimbal 200 receives a control instruction to turn on the fill light 30.

The fill light 30 may be turned on or off by the gimbal 200 besides being turned on and off manually. For example, in a low light condition, when an operation terminal sends to the gimbal 200 a control instruction to turn on the fill light 30, the gimbal 200 controls to turn on the fill light 30 of the photographing device 100. Further, the fill light hole is controlled to be closed to save energy and improve the endurance of the gimbal camera. In some embodiments, the operation terminal is a remote control device, such as a remote controller, a mobile phone, or another wireless communication device, and the operation terminal is equipped with control software for sending corresponding control instructions, which is convenient for operation.

In an embodiment, the gimbal camera also includes a handheld member 400 mounted at the gimbal 200. The gimbal 200 is mounted at the handheld member 400 to enable the handheld member 400 to manually control the operation of the gimbal 200 and the photographing device 100. In some embodiments, the handheld member 400 includes a handle and at least one operation member 401 provided at the handle, where the operation member 401 may be a control button or a wheel. The operation member 401 is used to control the gimbal 200 and/or the photographing device 100 to perform a corresponding function. For example, the operating member 401 is a control button, which is used to control the fill light 30 to be on or off, or to cooperate with another button to control the photographing device 100 to perform multiple functions, such as shooting the object, adjusting the brightness of the fill light 30 and the fill light effect. The operation member 401 may also be provided at the handle to control the rotation of the corresponding axis of the gimbal 200, to enable the photographing device 100 to obtain a suitable shooting angle and a shooting effect.

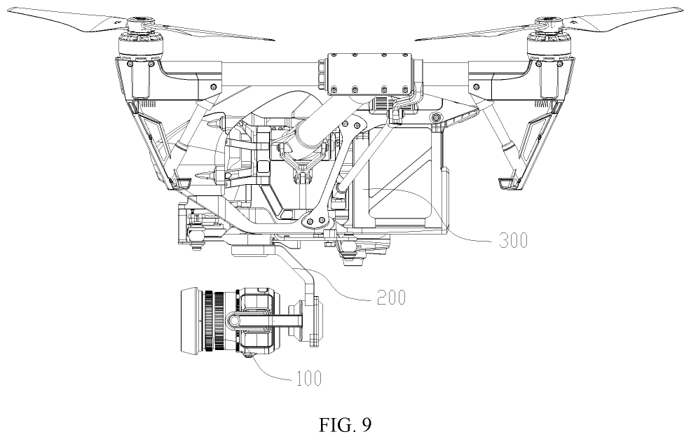

As shown in FIG. 9, the example gimbal camera described above in connection with FIG. 5 can be applied to an unmanned aerial vehicle. The unmanned aerial vehicle includes an aerial vehicle body 300 and the above-described gimbal camera. The aerial vehicle body 300 is communicatively connected to the gimbal camera.

The aerial vehicle body 300 may be configured as a four-rotor, six-rotor, eight-rotor, and another multi-rotor aerial vehicle structure, and the gimbal camera is mounted at the aerial vehicle body 300. The unmanned aerial vehicle can obtain corresponding image information via the photographing device 100 during flight. In addition, a user may manually control to turn on the fill light 30 according to the changes in the environment, or the aerial vehicle body 300 may control to turn on the fill light 30 by detecting the light intensity of the external environment, thereby improving the shooting quality of the photographing device 100. The fill light 30 may move synchronously with the shooting device 100 to achieve good consistency.

The relational terms, such as “first” and “second” are only used to distinguish one entity or operation from another entity or operation, which may not indicate or imply any such actual relationship or order between the entities or operations. The terms “include,” “contain,” and any other variants are intended to cover non-exclusive inclusion, which cause a process, method, article, or device including a series of elements not only includes the listed elements, but also includes other elements that are not explicitly listed, or elements inherent to the process, method, article, or device. Unless otherwise defined, the use of “including a . . . ” followed by an element does not exclude the existence of another same element in the process, method, article, or device.

The photographing device, gimbal camera, and unmanned aerial vehicle consistent with the embodiments of the present disclosure are described in detail above. Other embodiments of the disclosure will be apparent to those skilled in the art from consideration of the specification and practice of the embodiments disclosed herein. It is intended that the specification and embodiments be considered as example only and not to limit the scope of the disclosure, with a true scope and spirit of the invention being indicated by the following claims.

What is claimed is:

1. A photographing device comprising:
a housing;
a fill light mounted at the housing; and
a lens module mounted in the housing;
wherein:
relative position and attitude of the fill light relative to the lens module are fixed;
an optical axis of the fill light is approximately parallel to an optical axis of the lens module; and
the lens module and the fill light rotate together with the housing.

2. The photographing device of claim 1, further comprising:
a lens group;
wherein:
the housing includes a lens hole and a light hole arranged side by side;
the lens module is arranged corresponding to the lens hole;
the fill light is located in the light hole; and
the lens group is configured to cover the lens hole and the light hole.

3. The photographing device of claim 2, wherein the lens group includes:
a protection lens configured to cover the lens hole; and
a light guide lens configured to cover the light hole.

4. The photographing device of claim 3, wherein the light guide lens is plug-connected to the light hole.

5. The photographing device of claim 4, wherein the light guide lens includes:
a light guide member inserted to the light hole; and
a flange member mounted at the housing, the flange member protruding from the light guide member and matching the protection lens.

6. The photographing device of claim 3, wherein the light guide lens is separated from the fill light by a preset distance and configured to adjust an emission direction of light emitted from the fill light and transmitted through the light guide lens.

7. The photographing device of claim 6, wherein the light guide lens includes a Fresnel lens, and the fill light is located at a focal point of the light guide lens.

8. The photographing device of claim 3, wherein a side wall of the light guide lens abuts against and is smoothly connected to a side wall of the protection lens.

9. The photographing device of claim 2, wherein:
the housing further includes a casing and a hood mounted at the casing;
the lens hole and the light hole are arranged side by side at the hood; and
the lens module is mounted in the housing and extends towards the lens hole.

10. The photographing device of claim 9, wherein:
the casing is provided with a mounting hole;
the hood is mounted at the mounting hole; and
the lens group is mounted at the hood and configured to cover the lens hole and the light hole.

11. The photographing device of claim 9, wherein:
the casing includes a front casing and a rear casing detachably mounted at the front casing; and
the hood and the lens module are mounted at the front casing and located in a mounting space between the front casing and the rear casing.

12. The photographing device of claim 9, wherein the hood and the casing are snap-connected to each other.

13. The photographing device of claim 9, wherein:
the hood includes:
a lens cover member; and
a connector surrounding the lens cover member and detachably connected to the casing; and
the lens hole and the light hole are provided at the lens cover member and the lens hole and the light hole are separated from each other by a preset distance.

14. The photographing device of claim 1, wherein the fill light is mounted at the lens module or the housing, and the fill light is electrically connected to the lens module.

15. The photographing device of claim 14, wherein the fill light includes:
an elevated base mounted at the lens module or the housing; and
a luminous body mounted at the elevated base and electrically connected to the lens module.

16. The photographing device of claim 15, wherein the luminous body is inserted in the housing, and the elevated base is attached to the housing and encloses the luminous body in the housing.

17. The photographing device of claim 1, wherein:
the lens module includes a lens board detachably mounted at the housing, and a lens assembly mounted at the lens board; and
the lens board is configured to adjust a shooting direction of the lens assembly relative to the housing.

18. The photographing device of claim 17, wherein the lens board is provided with a contact electrically connected to the fill light.

19. A gimbal camera comprising:
a photographing device including:
a housing;
a fill light mounted at the housing; and
a lens module mounted in the housing;
wherein:
relative position and attitude of the fill light relative to the lens module are fixed;
an optical axis of the fill light is approximately parallel to an optical axis of the lens module; and
the lens module and the fill light rotate together with the housing; and
a gimbal coupled to the photographing device and configured to drive the photographing device to rotate and to adjust a shooting direction of the photographing device.

20. An unmanned aerial vehicle comprising:
an aerial vehicle body; and
a gimbal camera carried by the aerial vehicle body and communicatively coupled to the aerial vehicle body, the gimbal camera including:
a photographing device including:
a housing;
a fill light mounted at the housing; and
a lens module mounted in the housing;
wherein:
relative position and attitude of the fill light relative to the lens module are fixed;
an optical axis of the fill light is approximately parallel to an optical axis of the lens module; and
the lens module and the fill light rotate together with the housing; and
a gimbal coupled to the photographing device and configured to drive the photographing device to rotate and to adjust a shooting direction of the photographing device.
